(19) United States
(12) Patent Application Publication
(10) Pub. No.: US 2021/0033444 A1
(43) Pub. Date: Feb. 4, 2021

(54) FLUID DISPENSING DEVICE

(71) Applicant: Partha Rao Puskur, Herndon, VA (US)

(72) Inventor: Partha Rao Puskur, Herndon, VA (US)

(21) Appl. No.: 16/940,236

(22) Filed: Jul. 27, 2020

Related U.S. Application Data
(60) Provisional application No. 62/879,724, filed on Jul. 29, 2019.

(51) Int. Cl. G01F 11/26; B65D 47/06; B65D 51/24

(52) U.S. Cl. CPC G01F 11/263; B65D 51/24; B65D 47/06

(57) ABSTRACT

A fluid device generally comprises a staging reservoir which may receive a volume of fluid flowing from a primary reservoir via a controllable coupler, wherein the staging reservoir is usable to stage fluid within the device prior to pouring fluid from the device and is configured to allow a staged volume of fluid to be observed and/or measured in order to dispense a desired amount of fluid.

### RELATED APPLICATIONS

This application claims the benefit of U.S. Provisional Application No. 62/879,724, filed Jul. 29, 2019 the entire contents of which are incorporated herein by reference.

### FIELD OF THE DISCLOSURE

The present disclosure relates to fluid dispensing devices.

### SUMMARY

Various implementations of a fluid dispensing device are disclosed. A fluid or liquid dispensing device may be removably attachable to a primary reservoir in which a fluid may be disposed. In some implementations, the dispensing device may include a primary reservoir in which a fluid may be disposed. In some implementations, a dispensing device generally comprises a staging reservoir which may receive a volume of fluid flowing from the primary reservoir via a controllable coupler, wherein the staging reservoir is usable to stage fluid within the dispensing device prior to pouring fluid from the dispensing device and is configured to allow a staged volume of fluid to be observed and/or measured in order to dispense a desired amount of fluid. The controllable coupler may be used to prevent further flow of fluid from the primary reservoir following a staging of an amount of fluid and during a pouring of the staged amount of fluid from the device. One of many possible applications for a fluid dispensing device of the present disclosure is food preparation, wherein the device can be used to deliver a measured amount of fluid as may be needed to adhere to a recipe, without requiring the manipulation of a separate measuring device. As such, a single unit may be grasped and manipulated to measure and deliver a desired amount of fluid rather than conventional means which require both the manipulation of a container of fluid, for example a bottle of olive oil, and the manipulation of a measuring device, for example a measuring cup. Alternative methods are particularly cumbersome in comparison when considering one handed operations frequently used in food preparation, wherein alternative methods means generally require the following operations: a separate measuring cup is grasped, positioned and released; the olive oil bottle is grasped, manipulated to pour and measure a desired amount of olive oil, repositioned and released; the measuring cup is again grasped, then manipulated to dispense the measured amount, repositioned and released.

### BRIEF DESCRIPTION OF THE SEVERAL VIEWS OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of the disclosed subject matter.

FIG. 1 depicts an isometric view of an example implementation of a fluid dispensing device.

FIG. 2A depicts a cross section of the fluid dispensing device of FIG. 1 in a first configuration with control valve in a closed position.

FIG. 2B depicts a cross section of the fluid dispensing device of FIG. 1 in a second configuration with control valve in an open position.

FIG. 3A depicts an example primary reservoir removably attachable to a fluid dispensing device via an implementation of a coupler.

FIG. 3B depicts an example primary reservoir and an alternate implementation of a coupler of a fluid dispensing device.

FIG. 4 depicts a cross section view of an example implementation of check valve of a fluid dispensing device.

FIG. 5A depicts an isometric view of an alternate example implementation of check valve of a fluid dispensing device.

FIG. 5B depicts a cross section view of the alternate example implementation of check valve of FIG. 5A.

FIG. 6 depicts a cross section of an example implementation of a control valve of a fluid dispensing device.

FIG. 7A depicts an exploded view of an example implementation of a control valve assembly of a fluid dispensing device.

FIG. 7B depicts an assembled view the control valve assembly of FIG. 7A after a first assembly step.

FIG. 7C depicts an assembled view the control valve assembly of FIG. 7A after a second assembly step.

FIG. 7D depicts an assembled view the control valve assembly of FIG. 7A after a third assembly step.

FIGS. 8A-8F show side plan views of various implementations of a staging reservoir of a fluid dispensing device.

FIGS. 9A-9E show cross sections views of various staging steps of a dispensing method using a an example implementation of a fluid dispensing device.

FIG. 10 depicts an isometric view of an alternate example implementation of a fluid dispensing device.

FIG. 11 depicts an isometric view of an example implementation of a fluid dispensing device with a control valve that is oriented at an angle relative to a staging reservoir.

FIG. 12A depicts a side view of an alternate implementation of a staging reservoir that is able to swivel on a bearing.

FIG. 12B depicts an isometric view the swivel bearing of FIG. 12A.

FIG. 13 depicts an isometric view of an example implementation of a fluid dispensing device with a staging reservoir having side spouts and no control valve.

### DETAILED DESCRIPTION

Various detailed example implementations of a fluid dispensing device are disclosed herein; however, it is to be understood that the disclosed implementations are merely illustrative and may be embodied in various forms. In addition, each of the examples given in connection with the various implementations is intended to be illustrative, and not restrictive.

The following detailed example implementations refer to the accompanying drawings. The same reference number may appear in multiple drawings and when appearing in multiple drawings will identify the same or similar elements.

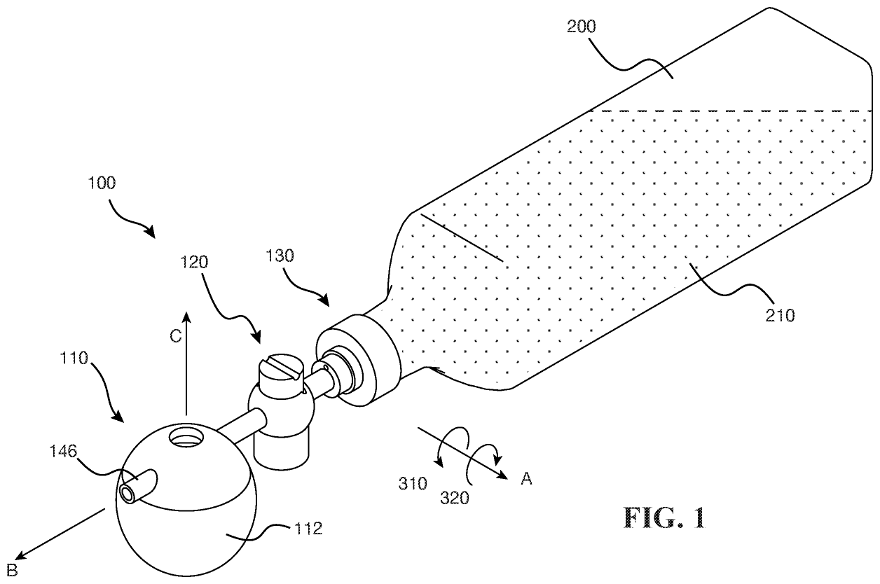

FIG. 1 depicts an example implementation of a fluid dispensing device 100. Device 100 comprises a fluid staging reservoir 110, a control valve 120, and a coupler 130 configured to connect to a primary reservoir 200, such as a bottle of fluid 210. In operation, device 100 and primary reservoir 200 are rotated about axis A in a counterclockwise direction 310 to move fluid 210 through device 100 generally in a direction B orthogonal to axis A. Fluid staging reservoir 110 includes a primary volume 112 that sits generally below a spout 146 in a direction C, such that fluid 210 enters the primary volume 112 before being dispensed from the staging reservoir 110 through the spout 146. In some implementations, axis A and directions B and C define a cartesian coordinate system with three mutually perpendicular planes.

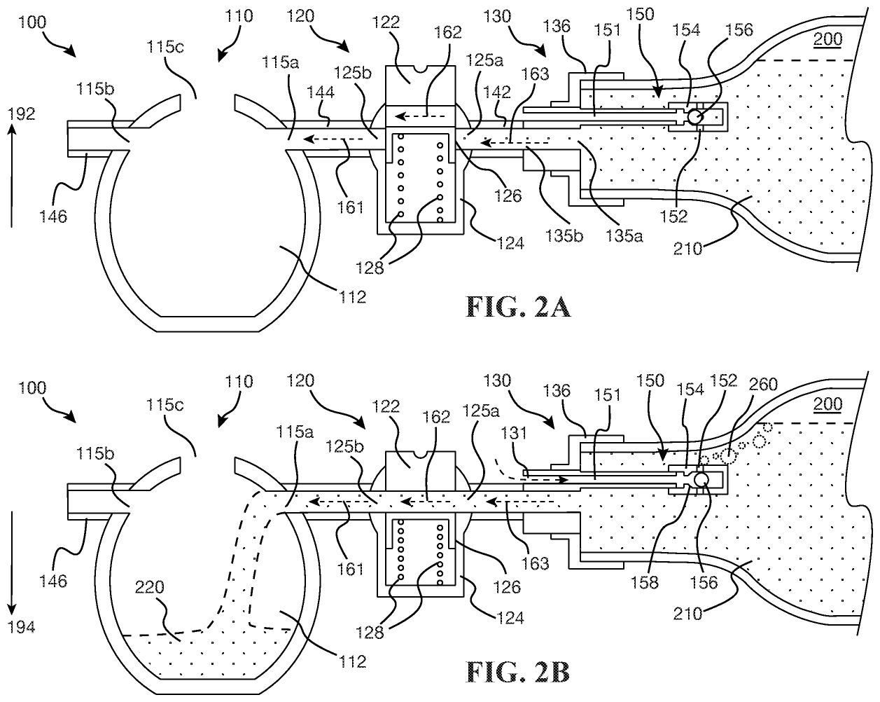

FIG. 2A depicts a cross section of an example implementation of the fluid dispensing device 100 of FIG. 1. Device 100 is configured to connect to a primary reservoir 200 via coupler 130. Coupler 130 includes a coupler securing body 136 configured to removably secure the coupler to the primary reservoir 200 such that a fluid 210 in primary reservoir 200 can flow into a coupler inlet 135a and out of a coupler outlet 135b. Control valve 120 includes valve input 125a configured to receive a fluid from coupler outlet 135b along a first dispensing path 163. In some implementations, coupler outlet 135a and valve inlet 125a are directly connected. In other implementations, coupler outlet 135a and valve inlet 125a are connected via a first conduit 142. It should be noted that when device 100 is taken as a whole and in some implementations, coupler outlet 135b and control valve inlet 125a may refer to the same point, part, location, component, feature and the like within device 100.

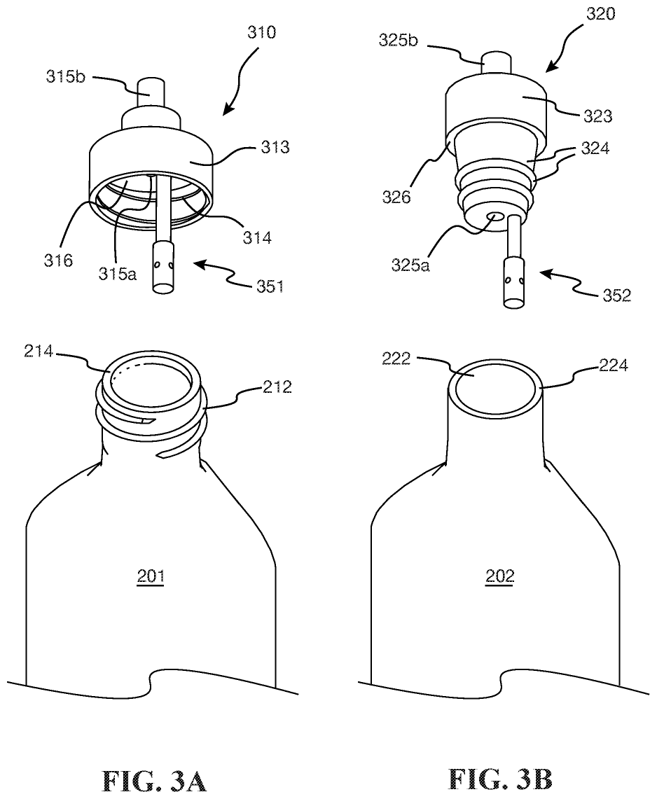

A primary reservoir may be one of many possible containers comprising fluid, such as a commercially available bottle of olive oil. FIG. 3A depicts an example primary reservoir 201. In some implementations, coupler 310 can be configured with similar features to a screw-on bottle cap, wherein a threaded bottle cap can be removed from a primary reservoir 201 and device 100 can be removably attached by threading a coupler mating surface 314 comprised by securing body 313 comprising screw threads to mate and thread onto a primary reservoir mating surface 212 also comprising mating screw threads. In some implementations, fastener 132 further comprises a coupler sealing surface 316 which seals against a primary reservoir sealing surface 214 when coupler 310 is sufficiently threaded and rotated onto primary reservoir 201 such that coupler sealing surface 316 is seated against primary reservoir sealing surface 214. This arrangement allows fluid held within primary reservoir 201 to controllably pass through coupler inlet 325a and out of coupler outlet 325b with little to no spillage. In some implementations check valve 351 extends from the coupler sealing surface 316 into the primary reservoir 201.

FIG. 3B depicts an example implementation of a coupler 320 comprising features similar to a bottle stopper, wherein a device 100 comprising a coupler of the implementation of 320 can be removably attached to a primary reservoir 202 by pressing a coupler mating surface 324 comprised by securing body 323 into a primary reservoir mating surface 222 such that a frictional retention and removable structural attachment is achieved. Coupler mating surface 324 may be comprised of a compressible material, such as, but not limited to, a food grade silicone rubber, to provide a persisting elastic force (e.g., elastic potential energy) and a conforming characteristic of coupler mating surface 324 thereby improving the amount of frictional retention provided. In the example implementation of FIG. 3B, coupler mating surface 324 and a coupler sealing surface 326 can be the same surface. Furthermore, primary reservoir mating surface 222 and a primary reservoir sealing surface 224 can be the same surface. As such, a coupler 320 comprised of a compressible material providing a conforming characteristic of coupler mating surface 324 may further improve a seal achieved between coupler sealing surface 326 and primary reservoir sealing surface 224. It should be appreciated that the mechanism to attach a coupler to a primary reservoir can be other suitable coupling mechanisms (e.g., locking bayonet couplers, glue, welding, etc.)

In some implementations, coupler 130 further comprises a return air inlet 131 (FIG. 2B). Return air inlet 131 allows air 260 to flow into an attached primary reservoir 200 and occupy volume made available by fluid 210 flowing from the attached primary reservoir 200 and into the coupler inlet 135a. In some implementations, coupler 130 further includes a check valve 150 that cooperates with return air inlet 131 to allow air to flow into primary reservoir 200, but restrict fluid 201 from flowing out of return air inlet 146. In some implementations, check valve 150 comprises a housing 154 comprising a check valve seat 158 and one or more check valve outlets 152, a movable seal 156 disposed in the housing 154, and a return air conduit 151 connecting the return air inlet 131 and housing 154. In some implementations, check valve seat 158 is positioned between return air inlet 131 and moveable seal 156 such that air flow entering return air inlet 146 may move movable seal 156 away from check valve seat 158 allowing air flow through check valve seat 158 and further through one or more check valve outlets 152. Check valve outlets 152 are located on the same side of check valve seat 158 as moveable seal 156. Fluid attempting to flow into check valve outlets 152 toward return air inlet 131 can move moveable seal 156 and seat it against check valve seat 158 thereby creating a seal and preventing the flow of fluid through check valve 150. Moveable seal 156 and check valve seat 158 can be of various geometries which provide a fluid seal when seated together and provide for air flow when not seated together. For example, moveable seal 156 can comprise a smooth spherical geometry and check valve seat 158 may comprise a mating smooth bowl shape geometry comprising an air flow path in the base of the bowl.

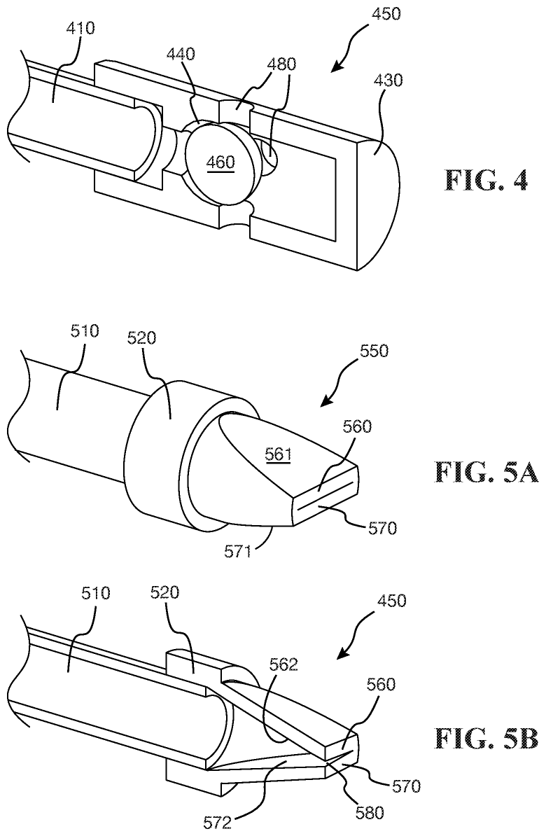

FIG. 4 shows a cross section of a check valve 450 with movable seal 460 partially removed from check valve seat 440. In this position, air entering return air conduit 410 can move into valve housing 430, past the check valve seat 440, around the movable seal 460, and out of check valve outlets 480. When fluid tries to move into the valve housing 430 through check valve outlets 480, the movable seal 460 is pressed against the check valve seat 440 to prevent fluid from entering return air conduit 410.

FIGS. 5A and 5B show an alternate implementation of a check valve 550. Check valve 550 is in the form of a duckbill valve having a valve body 520 attached to a return air conduit 510. Extending from the valve body 520 are two adjacent elastomeric flaps 560 and 570 with external surfaces 561 and 571, respectively. As seen in the cross sectional view of FIG. 5B, flaps 560 and 570 have internal surfaces 562 and 572, respectively. When air enters air return conduit 510, the pressure of the air acts on internal surface 562/572 to open the flaps 560/570, creating an opening 580 through which the air can enter a primary reservoir to restore equilibrium. When fluid presses against the external surfaces 561/571 of the flaps 560/570, the flaps are pressed together sealing off entry into the valve body 520. Check valves come in many different varieties, such as swing valves, tilting disc valves, diaphragm valves, etc., each of which can be used herein to provide one-way operation.

In some implementations, device 100 further comprises a control valve 120 positioned between coupler 130 and staging reservoir 110. In some implementations, control valve 120 is operable to selectively allow and restrict fluid flow into staging reservoir 110, and thereby may be used to control fluid flow from an attached primary reservoir. In the example implementation of device 100, control valve 170 comprises a control valve housing 124, a control valve inlet 125a and control valve outlet 125b defined therein, a button shutter 122, a second fluid dispensing path 162 defined therein, a button shutter wall 126, and a button shutter spring 128. Device 100 may be configured such that button shutter 122 may, in a one-hand operation, be operated while also holding and manipulating device 100 and an attached primary reservoir 200. In some implementations, device 100 may be configured such that control valve 120 may be grasped between a thumb and forefinger of a hand and operated by squeezing therebetween, and the base of the same hand may at least partially grasp and/or provide support for an attached primary reservoir.

In operation, button shutter 122 of control valve 120 travels along an axis within the geometry generally defined by control valve housing 124, wherein the travel is between a valve open position and a valve closed position. Arrow 192 of FIG. 2A indicates the direction of travel associated with a closing of control valve 120. Arrow 194 of FIG. 2B indicates the direction of travel associated with an opening of control valve 120. Control valve 120 is in a normally closed position, wherein button shutter spring 128 applies sufficient force to maintain button shutter 122 in a closed position as depicted in FIG. 2A. As can be seen in FIG. 2A, control valve 120 is configured such that when button shutter 122 is in a closed position, button shutter wall 126 obstructs first fluid dispensing path 163 at control valve inlet 125a and thereby shuts off fluid flow from coupler inlet 135b (and thereby shuts of fluid flow from an attached primary reservoir 200). In operation, button shutter 122 can be depressed with sufficient force to depress button shutter 122 and compress button shutter spring 128 such that button shutter 122 travels to an open position as depicted in FIG. 2B. As can be seen in FIG. 2B, control valve 120 is configured such that when button shutter 122 is in an open position, second fluid dispensing path 162 is aligned with first fluid dispensing path 163 at control valve inlet 125a, allows fluid to flow through control valve outlet 125b and through fluid staging reservoir inlet 115a along third fluid dispensing path 161. Therefore, when the control valve 120 is in the open position, fluid 210 can flow from attached primary reservoir 200 to fluid staging reservoir 110. In some implementations, control valve outlet 125b and fluid staging reservoir inlet 115a are directly connected. In other implementations, control valve outlet 125b and fluid staging reservoir inlet 115a are connected via a second conduit 144. It should be further noted that when device 100 is taken as a whole and in some implementations, control valve outlet 125b and staging reservoir inlet 115a may refer to the same point, part, location, component, feature and the like within device 100.

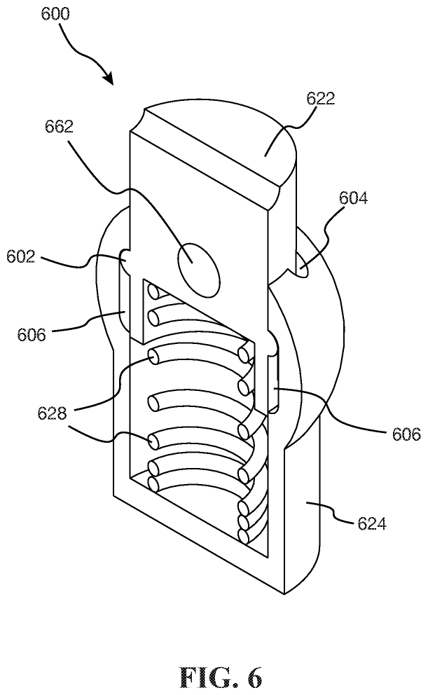

FIG. 6 depicts a cross section of an example implementation of control valve 600. In the example implementation of FIG. 6, button shutter 622 comprises two button shutter retention pins 602. Control valve housing 624 comprises two button shutter travel channels 606, wherein associated button shutter retention pins 602 may travel as button shutter 622 operates between a closed position and an open position. Button shutter spring 628 urges button shutter towards an open position, with retention pins 602 held at the top of the button shutter travel channels 602.

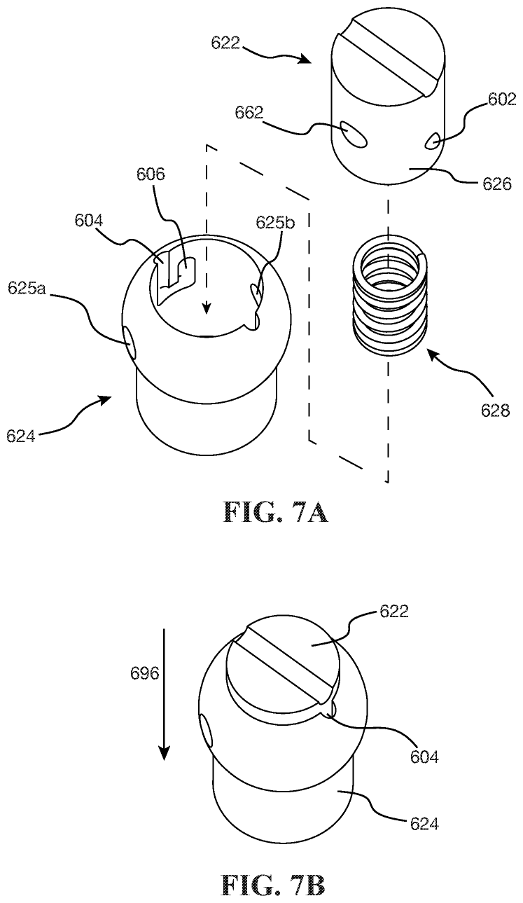

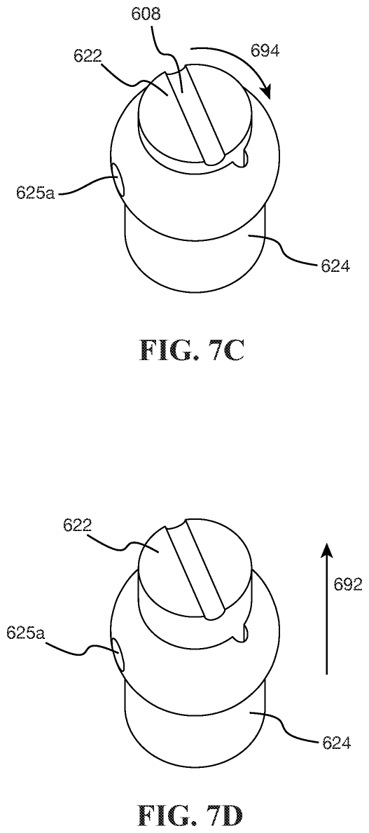

FIG. 7A depicts an exploded view of an example implementation of a control valve 600 of FIG. 6, and, with FIGS. 7B-7D, further serve to describe control valve 600 and its assembly. As can be seen depicted in the example implementation, control valve housing 624 further comprises two button shutter assembly channels 604, wherein an assembly procedure can be to: insert button shutter spring 628 into the control valve housing 624; next align button shutter retention pins 602 with button shutter assembly channels 604; then insert button shutter 622 into control valve housing 624 (FIG. 7B), compressing button shutter spring 628 until button shutter retention pins 602 have traversed button shutter assembly channels 604 in the control valve opening direction (FIG. 2B arrow 194); and rotate button shutter 622 in direction 694 (FIG. 7C) such that button shutter pins 602 rotate fully to button shutter travel channels 606, and second fluid dispensing path 662 is aligned with control valve inlet 625a and outlet 625b. Button shutter 622 may comprise a button assembly slot 608 (FIG. 7C) to assist the application of rotation force needed during the final assembly step (or initial disassembly step), wherein a tool such as a screw driver may assist in the procedure. When button shutter retention pins 602 reach button shutter travel channels 606, button shutter spring 628 urges button shutter 622 to its closed position, blocking control valve inlet 625a and outlet 625b with button shutter wall 626.

Referring back to FIG. 2A, staging reservoir 110 comprises a staging reservoir inlet 115a, a staging reservoir outlet 115b, and primary volume 112. Staging reservoir 110 may further comprise an access opening 115c, which may be used for access as required, such as access to provide other ingredients to be measured, for required for a cleaning operation, or may be used as an alternate outlet. Staging reservoir may alternately comprise a spout 146 provided at the staging reservoir to aid in directing a flow of dispensed fluid 220 from the staging reservoir 110.

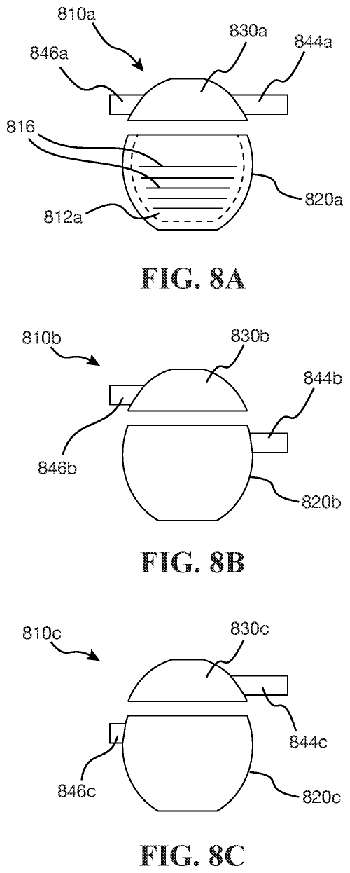

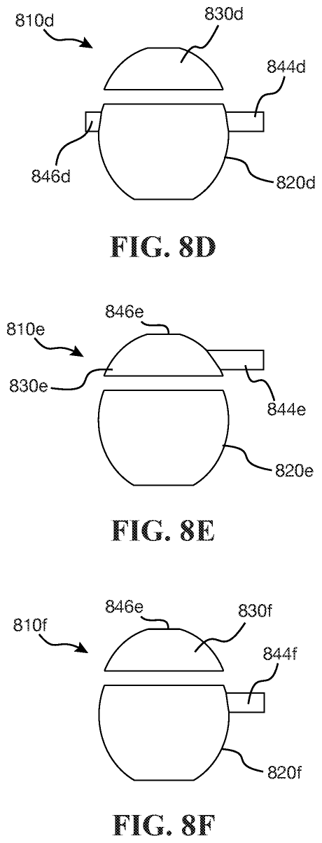

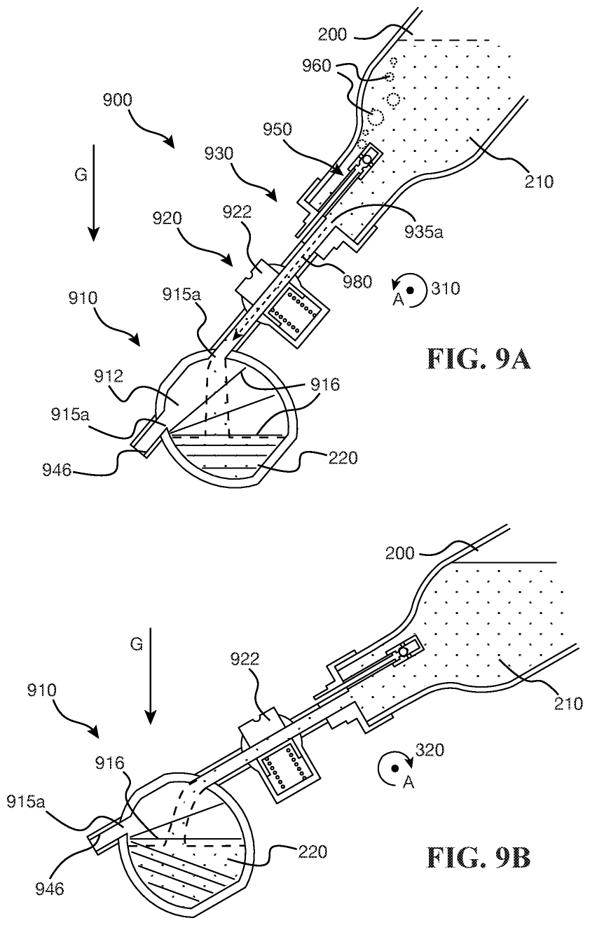

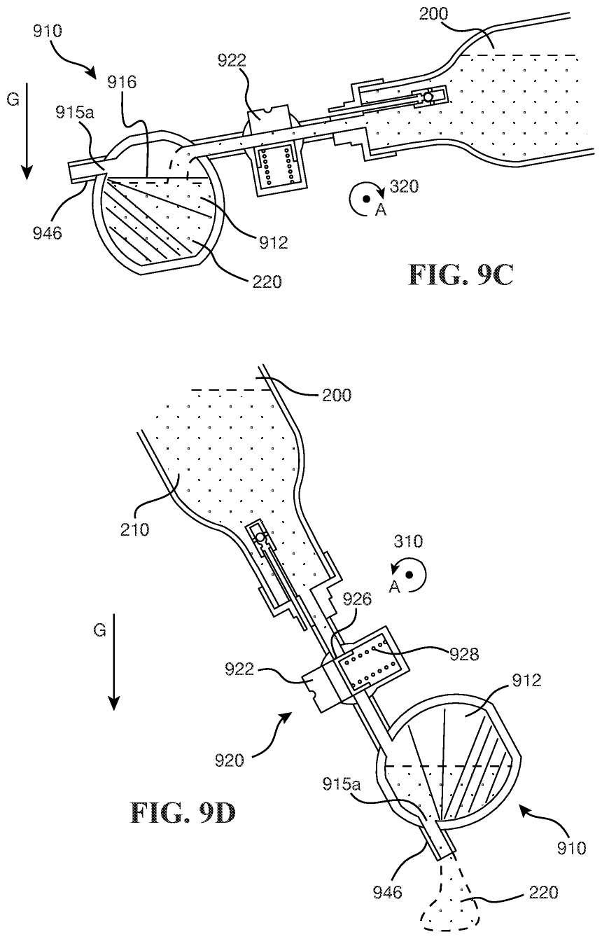

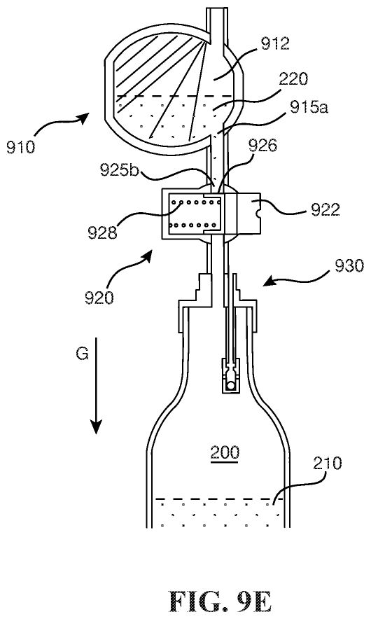

In some implementations, staging reservoir 110 may include two portions that are detachably coupled to facilitate easier access to cleaning the interior of the staging reservoir 110. When provided in two portions, the staging reservoir inlet 115a and outlet 115b may be on the same or different portions. Examples of the various configurations of the two portions of the staging reservoir 110 are illustrated in FIGS. 8A-8F. In FIG. 8A, staging reservoir 810a comprises an upper portion 830 and a lower portion 820. Lower portion 820 comprises the primary volume 812 configured to hold a staged volume of fluid prior to dispensing. Primary volume 812 may comprise graduated indicators 816 for indicating a volume measurement of fluid that may be staged in staging reservoir 810a. Indicators 816 are depicted in FIG. 8A as parallel lines and are generally visible on the outer surface(s) of staging reservoir 810a. In some implementations, indicators 816 are at least partially translucent or the staging reservoir 810a is at least partially translucent to enable a user to determine the level of fluid in staging reservoir 810a against the indicators 816. In some implementations, the indicators 816 are displayed in horizontal planes with respect to a plane of the device defined by axis A and direction B of FIG. 1. In some implementations, the indicators 816 are displayed at different angles with respect to the horizontal plane of the staging reservoir 810a to enable the user to gauge the volume of fluid that has entered the staging reservoir 810a (e.g. see FIG. 9A). In the implementation of FIG. 8A, both the staging reservoir inlet (with second conduit 844a attached thereto) and staging reservoir outlet (with spout 846a attached thereto) are located in the top portion 830a of staging reservoir 810a. In the implementation of FIG. 8B, the staging reservoir inlet (with second conduit 844b attached thereto) is located in the bottom portion 820b of staging reservoir 810b, and staging reservoir outlet (with spout 846b attached thereto) is located in the top portion 830b of staging reservoir 810b. In the implementation of FIG. 8C, the staging reservoir inlet (with second conduit 844c attached thereto) is located in the top portion 830c of staging reservoir 810c, and staging reservoir outlet (with spout 846c attached thereto) is located in the bottom portion 820c of staging reservoir 810c. In the implementation of FIG. 8D, both the staging reservoir inlet (with second conduit 844d attached thereto) and staging reservoir outlet (with spout 846d attached thereto) are located in the bottom portion 820d of staging reservoir 810d (and not in top portion 820d). In the implementation of FIG. 8E, both the staging reservoir inlet (with second conduit 844e attached thereto) and staging reservoir outlet (access opening represented as 846e) are located in the top portion 820e of staging reservoir 810e. In the implementation of FIG. 8F, the staging reservoir inlet (with second conduit 844f attached thereto) is located in the bottom portion 820f of staging reservoir 810f, and staging reservoir outlet (access opening represented as 846f) is located in the top portion 820f of staging reservoir 810f.

As seen in FIGS. 9A-9F, in some implementations, dispensing device 900 is configured such that a flow of fluid from an attached primary reservoir 200 to staging reservoir 910 via fluid flow path 980 may be generated by sufficiently elevating an attached primary reservoir 200 relative to staging reservoir 910, such as by rotating the device 900 and primary reservoir 200 about axis A in direction 310. An elevation, or in other words an orientation, which generates a flow of fluid 210 from an attached primary reservoir 200 to staging reservoir 910 via fluid flow path 980 while not exceeding a maximum staging elevation can be called a fluid staging orientation, and a range of such fluid staging orientations may be possible from a higher degree of sufficient elevation to a lower degree of sufficient elevation. In some implementations, when exceeding the maximum staging elevation, fluid may flow from staging reservoir 910 via staging reservoir outlet 915b; provided however, in various implementations, such a back flow of fluid can be controlled with a control valve 920.

General operation of device 900 comprises a staging operation and a pouring operation. In a staging operation, device 900 having an attached primary reservoir 200 is manipulated to a fluid staging orientation while operating control valve 920 in an open position (i.e., depressing button shutter 922) until a desired volume of fluid has flowed from the attached primary reservoir 200 to staging reservoir 910. As seen in FIG. 9A, graduated indicators 916 are disposed at various angles to allow for volume readings at associated pouring angles. The indicators 916 are generally perpendicular to the direction G of gravity at various staging angles. In FIG. 9A, a small amount of dispensed fluid can be dispensed into the primary volume 912 of the staging reservoir 910 at a high angle without concern for overflowing out of staging reservoir outlet 915b. The higher angle allows for faster dispensing. Check valve 150 is useful during this operation to prevent fluid 210 from exiting coupler 930, but allowing air 960 into the primary reservoir 200 to produce smoother fluid dispensing (e.g., without “glugging” when air attempts to enter via fluid outlets).

As the primary volume 912 fills up with dispensed liquid, the dispenser 900 and primary reservoir 200 can be rotated about axis A in direction 320 to avoid flowing out of staging reservoir outlet 915b as seen in FIGS. 9B and 9C. Once a desired volume of fluid is disposed in staging reservoir 910, control valve 920 can be operated in a closed position (e.g., releasing button shutter 922) and device 900 having the attached primary reservoir 200 can be manipulated to a fluid pouring orientation as seen in FIG. 9D. A fluid pouring orientation is one of a range of orientations, wherein staging reservoir 910 is rotated sufficiently for staging reservoir outlet 915B to be sufficiently lower in elevation than fluid staged in staging reservoir 910 such that the fluid pours from and drains from staging reservoir 910. Alternatively, if after a desired volume of fluid is disposed in staging reservoir 910 one does not want to immediately pour the dispensed fluid 220, control valve 920 can be operated in a closed position and the device 900 and primary reservoir 200 can be placed in a storage orientation as seen in FIG. 9E. In this storage orientation, button shutter wall 926 prevents dispensed fluid 220 from flowing back through control valve 920 and coupler 930, remaining separate from the fluid 210 in primary reservoir 200. Once ready, the device 900 and primary dispenser may be oriented such as in FIG. 9D to dispense the dispensed fluid 220.

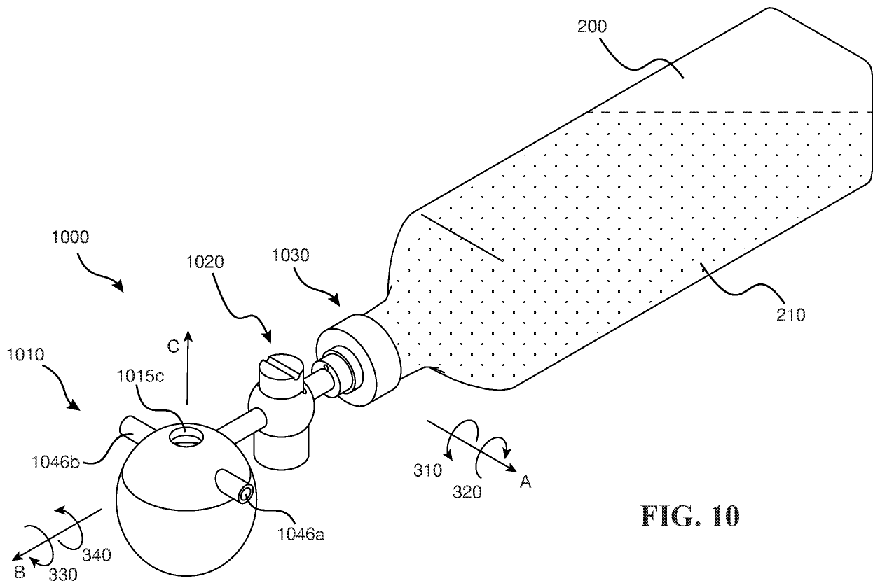

As shown in FIG. 10, in some implementations, device 1000 can include a staging reservoir 1010 that has staging reservoir outlets that are generally perpendicular to direction B. Staging reservoir can be filled as described above with respect to other implementations, i.e. device 1000 and primary reservoir 200 can be rotated in directions 310 and 320 about axis A while manipulating control valve 120 to allow fluid 210 to flow through coupler 1030, control valve 1020, and into staging reservoir 1010. However, to dispense the dispensed fluid from staging reservoir 1010, the device must be rotated about axis B in directions 340 or 360 to dispense out of spouts 1046a or 1046b. With this configuration, the device can be rotated to a staging angle greater than that of the implementation of FIGS. 9A-9E. Opening 1015c can still be used for dispensing, or for adding ingredients as mentioned previously.

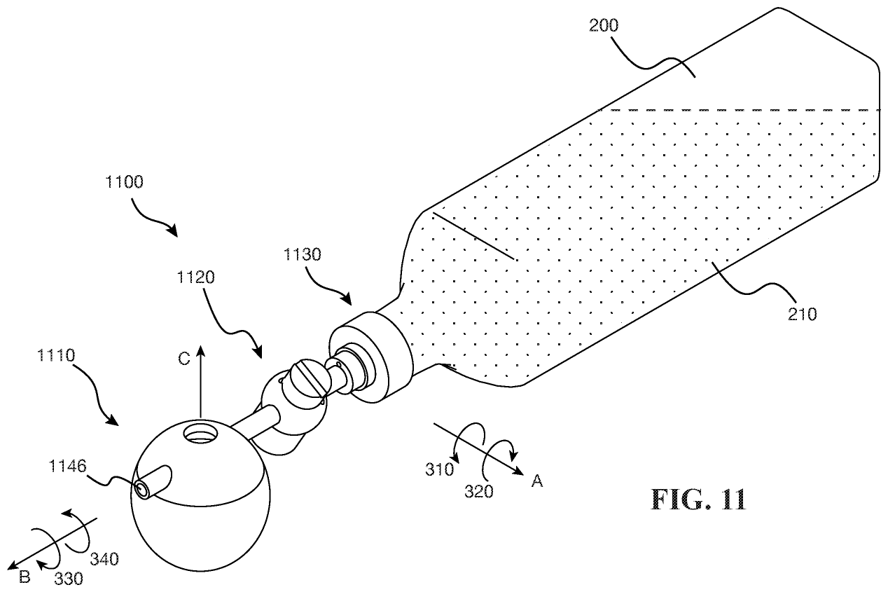

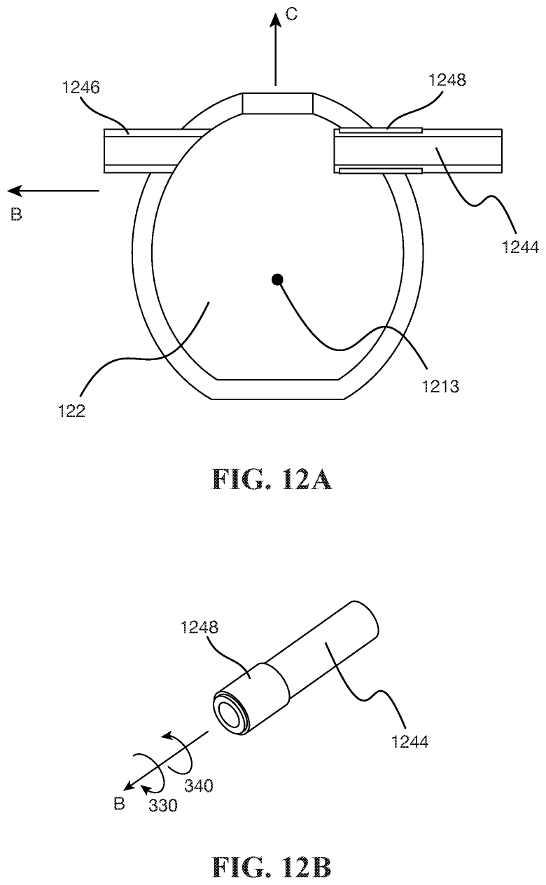

In some implementations, the control valve 1120 may be oriented at an angle with respect to the staging reservoir 1110 to better facilitate one handed operation of the dispensing device 1100. One example of the control valve 1120 at an angle with respect to the staging reservoir 1110 is illustrated in FIG. 11. In some implementations, the control valve 1120 can be rotated about axis B in direction 330 by an angle of approximately 30 degrees while the staging reservoir remains aligned with axis C. In some implementations, the angle can range between 30 degrees and 90 degrees, however other suitable angle can be used. In some implementations, the angle of the control valve 1120 is fixed with respect to the staging reservoir 1110. In some implementations, the angle of the control valve 1120 is alterable with respect to the staging reservoir 110 (e.g., the control value 1120 is user rotatable with respect to the staging reservoir 110, or the staging reservoir can swivel as in the implementation of FIG. 12A). In some implementations, the angle can be approximately 180 degrees out of phase from the angle noted above for a left-handed user. As seen in FIGS. 12A and 12B, the staging reservoir 1210 can be connected to a swivel arm 1244, which may act as a fluid conduit leading to a control valve. Swivel arm 1244 includes a swivel bearing 1248 that allows the staging reservoir 1210 to freely rotate. Staging reservoir 1210 includes a primary volume 1212 that has a center of mass 1213 that is below (with respect to direction C) the swivel arm 1244 and spout 1246 such that when the device, and attached swivel arm, are rotated about axis B in directions 330 or 340, the center of mass of primary volume 1212 of staging reservoir 1210 will rotate to a position to receive a maximum amount of fluid.

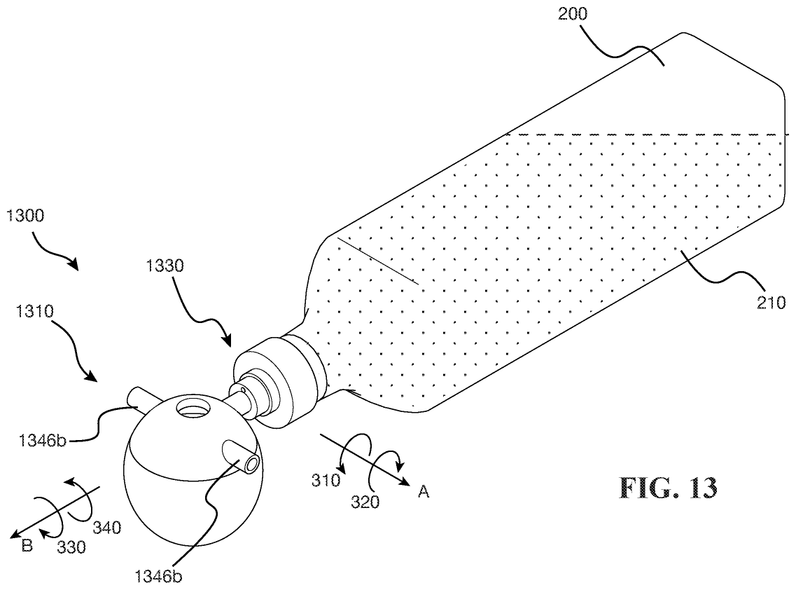

In some implementations, such as that shown in FIG. 13, a control valve may not be necessary. Device 1300 attached to primary reservoir 200 may be filled similarly to the implementation shown in FIG. 10. However, because a dispensing orientation does not include inclining the device 1300 and primary reservoir about axis A in direction 310 beyond a staging angle, the device can be rotated back in direction 320 to stop fluid 210 from being dispensed into staging reservoir 1310, and the device can be rotated about axis B in direction 330 or 340 to dispense staged fluid from spouts 1346a or 1346b.

The various structures and components in the example implementations described herein can be manufactured and assembled using various materials, such as plastics and metals, using various manufacturing methods, such as injection molding plastics, stamping and forming metals, and the like. For example, the control valve may possibly be manufactured using plastics and injection molding methods and the spring may be possibly formed from a spring grade steel. Where structures may be permanently connected, they can be glued, welded (e.g., sonically welded plastics), configured with mating threads and screwed together, compression fitted, formed and produced as one piece, and the like and combinations thereof. Staging reservoir 110 can be manufactured using materials which facilitate observation and measurement of a volume of fluid staged therein, such as a transparent or translucent plastic material. Or, in other possible implementations, staging reservoir 110 can be manufactured using a stainless-steel material and comprise a transparent or translucent window configured to facilitate observation and measurement of a volume of fluid staged therein. In some implementations, the non-moving parts of dispensing device 100 can be formed from a mold in two separate part and mated together.

A number of implementations of the fluid dispensing device have been described. Various modifications may be made without departing from the spirit and scope of the disclosed fluid dispensing device.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the dispensing device have been described. Various modifications may be made without departing from the spirit and scope of the invention.

What is claimed is:

1. A device for dispensing fluids having a fluid staging orientation and fluid pouring orientation, the device comprising:
a staging reservoir usable for measuring a volume of fluid therein and dispensing a volume of fluid therefrom comprising:
a staging reservoir inlet configured to receive fluid flowing into the staging reservoir when the device is in a fluid staging orientation; and
a staging reservoir outlet configured to dispense fluid flowing out of the staging reservoir when the device is in a fluid pouring orientation;
a coupler releasably attachable to a primary reservoir and in fluid communication with the staging reservoir, the coupler comprising:
a coupler mating surface configured to receive and releasably attach to a primary reservoir mating surface;
a coupler inlet configured to allow fluid to flow from the attached primary reservoir and into the coupler; and
a coupler outlet configured to deliver fluid from the coupler, with a first fluid flow path defined between the coupler inlet and the coupler outlet;
a control valve positioned between the coupler outlet and staging reservoir inlet, the control valve operable to selectively allow and restrict fluid flow between the coupler outlet and staging reservoir inlet along a second fluid flow path, wherein:
when the control valve is operating to allow fluid to flow into the staging reservoir inlet and the device is in a staging orientation, fluid disposed in the primary reservoir flows therefrom through the coupler input and into the staging reservoir, thereby staging a volume of fluid in the staging reservoir; and
when the control valve is operating to restrict fluid flow and the device is in a fluid pouring orientation, fluid does not flow from the primary reservoir and fluid flows from the staging reservoir outlet; and
wherein fluid staged within the staging reservoir flows from the staging reservoir outlet when the device is in a fluid pouring orientation.

2. The device of claim 1, wherein the staging reservoir includes one or more graduated indicators for indicating one or more volumes of fluid and usable for measuring a volume of fluid staged in the staging reservoir.

3. The device of claim 1 wherein the coupler further comprises a return air inlet configured to allow air to flow into the attached primary reservoir and occupy volume made available by fluid flowing from the attached primary reservoir and into the coupler inlet.

4. The device of claim 3, further comprising a check valve connected to the air return opening to allow air into the primary reservoir while preventing fluid from flowing through the return air inlet.

5. The device of claim 4, wherein the check valve comprises an air conduit, a check valve body receiving air from the air return opening via the air conduit, a movable seal disposed within the check valve body, a check valve seat in the check valve body between the air conduit and the movable seal, and one or more check valve outlets, wherein air coming through the air conduit pushes the movable seal away from the check valve seat and flows out of the check valve body through the one or more check valve outlets, and wherein fluid coming through the one or more check valve outlets pushes the movable seal against the check valve seat, preventing fluid from entering the air conduit and out of the air return opening.

6. The device of claim 1 wherein the coupler further comprises a coupler sealing surface configured to receive and seal to a primary reservoir sealing surface.

7. The device of claim 1 wherein when the device is in the fluid staging orientation fluid is staged in the staging reservoir in a primary volume that is below a straight line drawn between the staging reservoir inlet and staging reservoir outlet with respect to gravity.

8. The device of claim 1 wherein the coupler mating surface and primary reservoir mating surface are configured as cooperating threaded couplings.

9. The device of claim 1 wherein the coupler mating surface and primary reservoir mating surface are configured as cooperating press-fit couplings.

10. A device for dispensing fluid from a primary reservoir, the device comprising:
a coupler configured to releasably connect to the primary reservoir; and
a staging reservoir in fluid communication with the coupler, the staging reservoir comprising a staging reservoir inlet for receiving fluid through the coupler from the primary reservoir, a primary volume usable for receiving the fluid from the staging reservoir inlet, and a staging reservoir outlet for dispensing a volume of fluid from the primary volume;
wherein the device is rotatable to a staging orientation to allow a desired amount of fluid to be dispensed to move from the primary reservoir to the staging reservoir, and is further rotatable to a dispensing orientation different from the staging orientation to dispense desired amount of fluid from the staging reservoir through the staging reservoir outlet.

11. The device of claim 10, further comprising a control valve disposed between the coupler and the staging reservoir, the control valve operable between an open position that allows fluid to flow between the coupler and the staging reservoir, and a closed position to prevent fluid from flowing between the coupler and the staging reservoir.

12. The device of claim 11, wherein the coupler further includes an air return opening to allow air into the primary reservoir.

13. The device of claim 12, wherein the device further comprises a check valve connected to the air return opening to allow air into the primary reservoir while preventing fluid from exiting the primary reservoir.

14. The device of claim 13, wherein the check valve comprises an air conduit, a check valve body receiving air from the air return opening via the air conduit, a movable seal disposed within the check valve body, a check valve seat in the check valve body between the air conduit and the movable seal, and one or more check valve outlets, wherein air coming through the air conduit pushes the movable seal away from the check valve seat and flows out of the check valve body through the one or more check valve outlets, and wherein fluid coming through the one or more check valve outlets pushes the movable seal against the check valve seat, preventing fluid from entering the air conduit and out of the air return opening.

15. The device of claim 13, wherein the check valve is a duckbill valve.

16. The device of claim 11, wherein the control valve comprises:
a control valve body having a control valve inlet and control valve outlet;
a button shutter having a fluid dispensing path defined therethrough, the button shutter movable between an open position and a closed position, wherein the button shutter fluid dispensing path is aligned with the control valve inlet and control valve outlet to allow fluid to pass therethrough when in the open position, and the button shutter blocks the control valve inlet and control valve outlet from allowing fluid to pass between when in the closed position; and
a button shutter spring that biases the button shutter to the closed position.

17. The device of claim 10, wherein the device is rotated about a first direction to a staging orientation, and rotated about a second direction to orient the device in a dispensing orientation, wherein the first direction and second direction are substantially perpendicular.

18. A method of dispensing fluid from a primary reservoir, the method comprising the steps of:
providing a dispensing device having a coupler, a control valve, and a staging reservoir;
securing the coupler to the primary reservoir;
rotating the device and primary reservoir about a first axis in a first direction to a staging orientation;
opening the control valve to allow fluid to flow from the primary reservoir, through the coupler and the control valve, and into the staging reservoir;
closing the control valve once a desired amount of fluid has been received in the staging reservoir; and
rotating the device and primary reservoir to a dispensing orientation to dispense the fluid from the staging reservoir.

19. The method of claim 18, wherein the step of rotating the device and primary reservoir to a dispensing orientation includes rotating the device and primary reservoir control valve about the first axis in the first direction beyond the staging orientation.

20. The method of claim 18, wherein the step of rotating the device and primary reservoir to a dispensing orientation includes rotating the device and primary reservoir control valve about a second axis that is substantially perpendicular to the first axis.
